(19) United States
(12) Patent Application Publication
(10) Pub. No.: US 2021/0303774 A1
(43) Pub. Date: Sep. 30, 2021

(54) SUMMARY SENTENCE CALCULATION APPARATUS, SUMMARY SENTENCE CALCULATION METHOD AND PROGRAM

(71) Applicant: Nippon Telegraph and Telephone Corporation, Tokyo (JP)

(72) Inventors: Akio WATANABE, Tokyo (JP); Hiroki IKEUCHI, Tokyo (JP)

(21) Appl. No.: 17/264,132

(22) PCT Filed: Aug. 5, 2019
(86) PCT No.: PCT/JP2019/030728

§ 371 Date: Jan. 28, 2021

(30) Foreign Application Priority Data
Aug. 6, 2018 (JP) 2018-147837

(51) Int. Cl. G06F 40/151; G06F 40/166

(52) U.S. Cl. CPC G06F 40/151; G06F 40/166

(57) ABSTRACT

A summary sentence calculation apparatus, including: input means which inputs a set of sentences; and summary sentence calculating means which calculates a summary sentence set from the set of sentences, wherein the summary sentence calculating means repetitively executes processing, until the processing ends, of selecting a predetermined sentence from the set of sentences, calculating, when the predetermined sentence is added to a new summary sentence set, an amount of increase of coverage by the summary sentence set after the addition relative to coverage by the summary sentence set prior to the addition, outputting the summary sentence set prior to the addition and ending the processing when the amount of increase is smaller than a first threshold, and adopting the summary sentence set after the addition as a new summary sentence set when the amount of increase is equal to or larger than the first threshold.

### TECHNICAL FIELD

The present invention relates to a technique for calculating a summary sentence from a set of sentences. An example of a field of application of the technique is a workflow visualization system that visualizes an action sequence from an operation record document.

### BACKGROUND ART

In IT systems which are becoming increasingly large-scale and multifaceted in terms of components thereof, diversification of types of occurred failures and increasing complexity of such failures have become a problem. The diversification and increasing complexity of failures make it difficult to identify a cause of an abnormality that has occurred and to decide now to deal with the abnormality and, consequently, increase a period of time from failure to recovery.

For the purpose of preventing a delay in recovery due to a delay in response decision, there are techniques for visualizing a process of failure response in a format referred to as a workflow (NPL 1, PTL 1 to PTL 3). The techniques involve, upon failure occurrence, extracting a document in which is recorded an operation performed during a previous occurrence of a same cause of failure from a database, analyzing a process of failure response from the document, and visualizing the process using a graph referred to as a workflow. The visualization of a workflow is constituted by extracting sentences and symbol sequences (actions) that indicate a same operation or a same state and visualizing a transition of actions.

A simplest method to display contents of each action is to display all sentences considered to be a same action. However, with this method, all sentences corresponding to an action of data given to input end up being displayed. For example, an appearance of ten or more sentences that indicate a single action significantly impairs visibility. Given that the sentences indicate a same action, there is a need to reduce verbose descriptions.

In other words, when displaying an action, from the perspective of readability, it is required that the action be described by a minimum necessary sentence.

In order to describe an action by a minimum necessary sentence, for example, a method of displaying any one of sentences indicating a same action is conceivable. However, with this method, there is a possibility that an important description ends up being overlooked. Determinations of sentences indicating a same action may not necessarily be performed without error. Supposing that a sentence indicating an important action is erroneously considered to be the same as another action, with single-sentence display, one of the actions is not to be displayed on a workflow. In addition, descriptions of an action may include a description of complementary information, and a random selection of a sentence may result, in hiding valuable complementary information. In system operation, since an omission of work may cause a failure, all necessary pieces of information are desirably displayed without exception.

Conventional summary sentence calculation methods may conceivably be used in order to describe an action by a minimum necessary sentence. As a conventional summary sentence calculation method, an optimization problem definition by Lin et al. for selecting a combination of sentences which includes words included in a given set of sentences at or above a certain rate and which has a smallest number of words (NPL 2) and a solution thereof using a greedy algorithm (NPL 3) is proposed. This method may be summarized as follows.

Let S denote a set of sentences to be input and V⊥S denote a subset created by selecting any of the sentences in S. Furthermore, let fₛ(V) represent a ratio of words included in any of the sentences in V among all words included in S. Since fₛ(V) represents how many of the words in S are covered by the words in V, fₛ(V) is referred to as coverage. When V=S, fₛ(V)=1, and when V=Φ, fₛ(V)=0. In summary sentence calculation using the method of Lin et al., among V of which fₛ(V) is larger than a specified threshold 0≤r≤1, V that minimizes a sum of the number of words in sentences included in V is obtained.

The problem described above may be represented by a mathematical expression as follows.

min.Σ_{s∈V}|s, subject to. fₛ(V)≥r.

In the expression presented above, |s|0 represents the number of words included in a sentence s. Although the minimization problem described above is NP-hard, an approximate solution with guaranteed accuracy can be obtained by the solution based on a greedy algorithm according to NFL 3. With this method, among S, sentences v* that most increase fₛ(V) is selected one at a time and added to V until fₛ(V)≥r. A pseudo-code of this method will be shown below.

Let V=Φ.

While fₛ(V)≤r:

v*=argmax_{s∈s}(fₛ(V∪{s})−fₛ(V))/|s|

V=V∪{v*}

Return V as solution.

It should be noted that this method differs from a method which is most frequently used in multi-document summarization and which is constrained by an upper limit of the number of words. In multi-document summarization, many methods employ Σ_{s∈v}|s| as a constraint instead of an objective function so that a summary sentence is kept within a certain number of words. However, an important constraint on the visualization of a workflow is that the number of words is not specifically limited and that necessary information is covered.

Therefore, the constraint is a coverage function fₛ(V) that indicates completeness of information of a document and a threshold of a constraint that is specified by a user is given by a lower limit r of coverage instead of the number of words.

The method of Lin et al. enables a summary sentence that excludes verbose sentences to be created. As described above, when displaying an explanation of an action, all of the pieces of information that are included in a set of sentences determined to represent a same action must be displayed while omitting verbose descriptions. With the method of Lin et al., when there is a word that is included in S in a large number, adding a sentence s that includes the word to V is likely to increase fₛ(V) as compared to adding a sentence that does not include the word. Furthermore, newly adding a word that is already included in V does not increase fₛ(V). Therefore, in order to increase fₛ(V) with a small number of words, the method of Lin et al. enables a summary sentence to be created so as to avoid including a same word in the summary sentence.

### CITATION LIST

### Patent Literature

[PTL 1] Japanese Patent Application Laid-open 240. 2016-53871

### [PTL 2] Japanese Patent Application Laid-open No. 2018-55327

### [PTL 3] Japanese Patent Application Laid-open No. 2017-228094

### Non Patent Literature

[NPL 1] Akio Watanabe, Keisuke Ishibashi, Tsuyoshi Toyono, Keishiro Watanabe, Tatsuaki Kimura, Yoichi Matsuo, Kohei Shiomoto and Ryoichi Kawahara “Workflow Extraction for Service Operation Using Multiple Unstructured Trouble Tickets”, IEICE Transactions on Information and Systems, E101-D, No. 4, pp. 1030-1041, 2018.

[NPL 2] Hui Lin and Jeff Bilmes, “A Class of Submodular Functions for Document Summarization”, In Proceedings of the 49th Annual Meeting of the Association for Computational Linguistics: Human Language Technologies, Vol. 1, pp. 510-520. 2011
[NPL 3] Laurence A. Wolsey, “An analysis of the greedy algorithm for the submodular set covering problem”, Combinatorica, Vol. 2, No. 4, pp. 385-393, 1982.

### SUMMARY OF THE INVENTION

### Technical Problem

With a greedy algorithm based on the method of Lin et al. which is prior art, processing of selecting, one at a time, sentences that most increase fₛ(V) is repeated, and how much of words in all sentences are covered by sentences selected thus far is solely adopted as a selection criterion of sentences.

However, in reality, since words that differ from one event to the next such as apparatus names and apparatus numbers are present in an operation record, an algorithm end determination according to the threshold r may not always operate in an appropriate manner. Such an example will be described with reference to FIG. 1.

As shown in (a) in FIG. 1, let us consider a set that is a collection of 50 sentences which read “Replace port 1”, “Replace port 2”, . . . and which only differ in port numbers. In this case, since coverage of the word “replace” that is an invariant portion with respect to the entire sentence set is approximately half and coverage of each port number that is a variable portion with respect to the entire sentence set is 0.01, supposing that a lower limit r of coverage is set to 0.7, 20 sentences that indicate more or less the same meaning end up being selected as shown in (b) in FIG. 1.

As described above, in operation records, words that differ from one sentence to the next such as apparatus names may sometimes take up a majority of coverage. Therefore, in prior art, there is a problem in that, creating a summary so as to encompass even sentences with only a slightest difference in words for the purpose of increasing coverage results in an insufficient summary that retains a large number of verbose descriptions.

The present invention has been made in consideration of the point made above and an object thereof is to provide a technique for calculating, from a set of sentences, a summary constituted by a set of minimum necessary sentences.

### Means fox Solving the Problem

The disclosed technique provides a summary sentence calculation apparatus, including: input means which inputs a set of sentences; and summary sentence calculating means which calculates a summary sentence set from the set of sentences, wherein the summary sentence calculating means repetitively executes processing, until the processing ends, of selecting a predetermined sentence from the set of sentences, calculating, when the predetermined sentence is added to a new summary sentence set, an amount of increase of coverage by the summary sentence set after the addition relative to coverage by the summary sentence set prior to the addition, outputting the summary sentence set prior to the addition and ending the processing when the amount of increase is smaller than a first threshold, and adopting the summary sentence set after the addition as a new summary sentence set when the amount of increase is equal to or larger than the first threshold.

### Effects of the Invention

According to the disclosed technique, a summary constituted by a set of minimum necessary sentences can be calculated from a set of sentences.

### BRIEF DESCRIPTION OF DRAWINGS

FIG. 1 is a diagram illustrating a problem.

FIG. 2 is a functional configuration diagram of a summary sentence display apparatus according to an embodiment.

FIG. 3 is a diagram showing an example of information stored in an operation record DB.

FIG. 4 is a diagram showing an example of a workflow that is generated by a workflow generating unit.

FIG. 5 is a diagram showing an example of a workflow in which actions are displayed in a simplified manner by a summary sentence calculating unit.

FIG. 6 is a hardware configuration diagram of the summary sentence display apparatus.

FIG. 7 is a flow chart of processing by the summary sentence calculating unit.

FIG. 8 is a diagram illustrating a specific example of the processing by the summary sentence calculating unit.

### DESCRIPTION OF EMBODIMENTS

Hereinafter, an embodiment of the present invention (the present embodiment) will be described with reference to the drawings. It is to be understood that the embodiment described below is merely an example and embodiments to which the present invention is applied is not limited to the following embodiment.

While an example in which the present invention is applied to display of a workflow is presented in the embodiment described below, the present invention is not limited to the display of a workflow and can be applied to various technical fields.

### Functional Configuration and Overall Operation of Apparatus

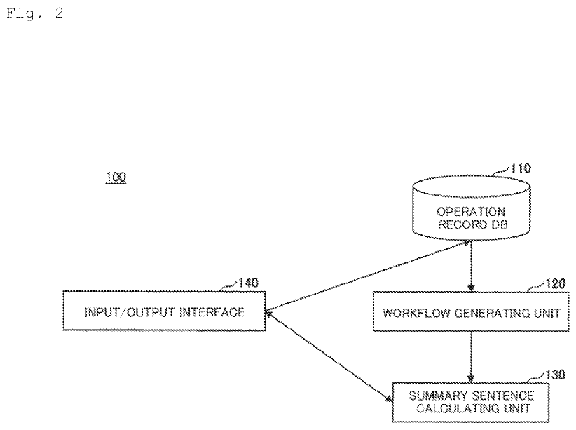

FIG. 2 is a functional configuration diagram of a summary sentence display apparatus 100 according to an embodiment of the present invention. The summary sentence display apparatus 100 according to the present embodiment is an apparatus which displays a workflow by determining a sentence to be displayed at each node of a graph which is referred to as an action in a workflow.

As shown in FIG. 2, the summary sentence display apparatus 100 has an operation record DB 110, a workflow generating unit 120, a summary sentence calculating unit 130, and an input/output interface 140. Alternatively, the summary sentence display apparatus 100 may be referred to as a summary sentence calculation apparatus. In addition, the summary sentence calculating unit 130 may be constructed as a single apparatus, in which case the apparatus may be referred to as the summary sentence calculating unit 130.

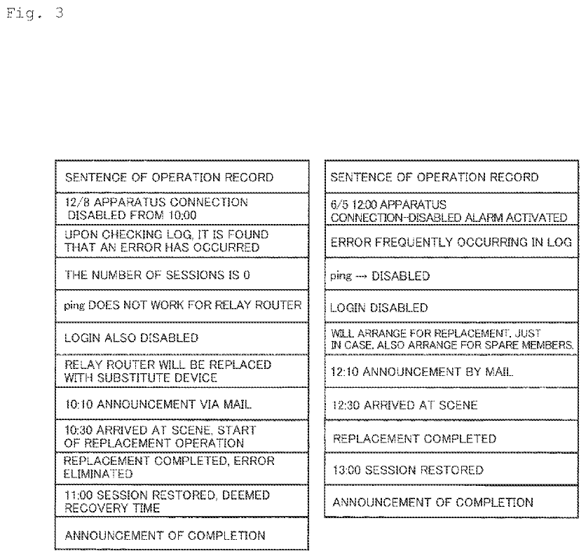

The operation record DB 110 stores causes and information on operation records with respect to past failures. The information on operation records is a set of operation record sentences in which operation contents are recorded. The set of operation record sentences is input from the input/output interface 140 and stored in the operation record DB 110. FIG. 3 shows an example of a set of sentences that is stored in the operation record DB 110. As shown in FIG. 3, in the document data, a same content is recorded as different expressions.

Based on a designation of an operation record for generating a workflow from the input/output interface 140, the workflow generating unit 120 reads out a set of sentences of an operation record from the operation record DB 110. In addition, using the method described in NPL 1 or the like, the workflow generating unit 120 generates a graph having actions and transitions between the actions as a workflow. A workflow is constituted by actions and transitions thereof. An action refers to a set of sentences indicating a same operation and the like in an input operation record.

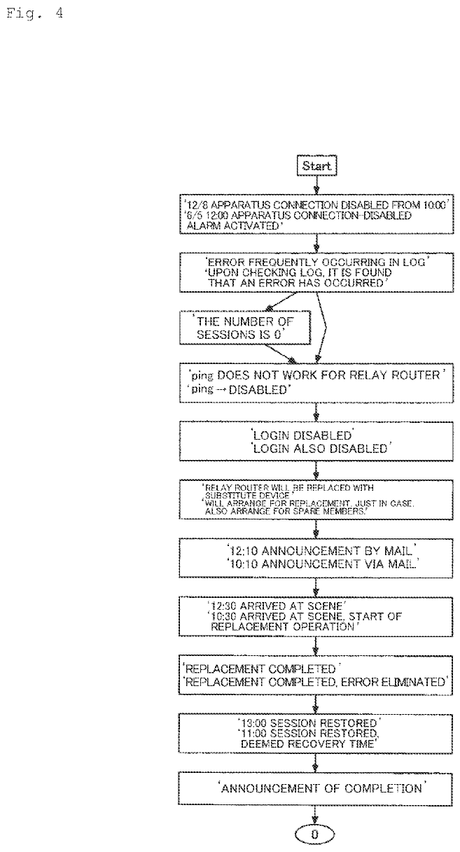

More specifically, the workflow generating unit 110 defines a similarity between sentences, and by finding a combination of sentences that maximizes the similarity, discovers a sentence indicating a same action in a document. In addition, by connecting discovered actions in accordance with a description order of sentences in the document, a transition from an action to a next action is drawn to visualize a workflow. FIG. 4 shows an example of a workflow generated based on the operation record shown in FIG. 3.

The summary sentence calculating unit 130 performs summarization processing with respect to each action that is included in the workflow obtained by the workflow generating unit 120. The summary sentence calculating unit 130 is given a set of ail sentences indicating a same action as input. In addition, the summary sentence calculating unit 130 outputs a sentence or a set of sentences to be displayed at each node of a graph which indicates an action. The output sentence or the output set of sentences is never longer than the input set of sentences and is to be displayed in a more simplified manner.

In other words, the summary sentence calculating unit 130 calculates a sentence to be displayed in each action in a workflow as a minimum necessary sentence so that information included in the given sentence set is exhaustively displayed but, at the same time, slight differences in words are not considered necessary to be covered and are hidden, in addition, the summary sentence calculating unit 130 presents a user with a display sentence through the input/output interface 140.

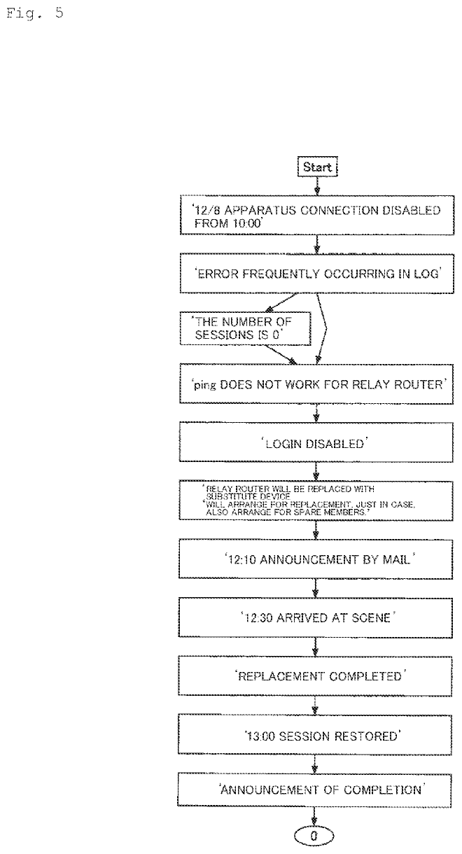

FIG. 5 shows an example of a workflow using a summary sentence calculated by the summary sentence calculating unit 130 when the operation record shown in FIG. 3 is used. As shown in FIG. 5, in most actions, since description contents are the same, only one sentence is displayed. Only a sixth action mentions making arrangements for a spare member which is complementary information and is therefore displayed as two sentences without being summarized. FIG. 5 shows that, in this manner, a display amount of each node indicating an action has been reduced and readability is higher as compared to the workflow shown in FIG. 4.

In this manner, by displaying all information included in sentences determined to represent a same action while omitting verbose descriptions, both a decline in visibility due to verbose descriptions of actions and operation errors due to omission of display of operations can be prevented.

Further details of contents of processing by the summary sentence calculating unit 130 will be provided later.

### Hardware Configuration Example

The summary sentence display apparatus 100 described above can be realized by, for example, causing a computer to execute a program that describes processing contents to be described in the present, embodiment.

Specifically, the summary sentence display apparatus 100 can be realized using hardware resources such as a CPU and a memory that are built into a computer by executing a program that corresponds to processing performed by the summary sentence display apparatus 100. The program can be recorded in a computer-readable recording medium (a portable memory or the like) to be saved or distributed. In addition, the program can be provided through a network such as the Internet or in the form of an e-mail.

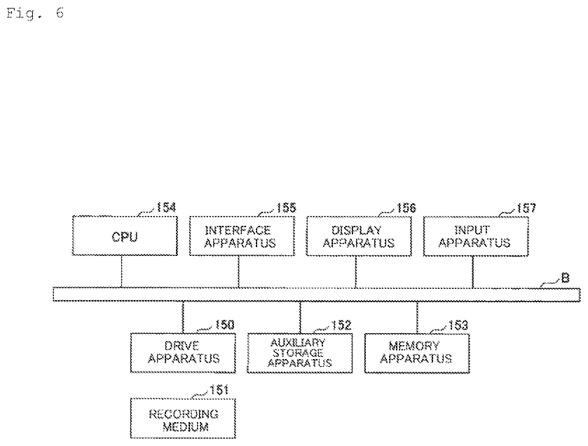

FIG. 6 is a diagram showing a hardware configuration example of the computer described above according to the present embodiment. The computer shown in FIG. 6 has a drive apparatus 150, an auxiliary storage apparatus 152, a memory apparatus 153, a CFU 154, an interface apparatus 155, a display apparatus 156, an input apparatus 157, and the like which are mutually connected by a bus B.

A program that realizes processing by the computer is provided by the recording medium 151 that is a CD-ROM, a memory card, or the like. When the recording medium 151 storing the program is set to the drive apparatus 150, the program is installed from the recording medium 151 to the auxiliary storage apparatus 152 via the drive apparatus 150. However, the program need not necessarily be installed from the recording medium 151 and, alternatively, the program may be downloaded by another computer via a network. The auxiliary storage apparatus 152 stores the installed program as well as necessary files, data, and the like.

When an instruction to run the program is issued, the memory apparatus 153 reads out and stores the program from the auxiliary storage apparatus 152. The CPU 154 realizes functions related to the summary sentence display apparatus 100 in accordance with the program stored in the memory apparatus 153. The interface apparatus 155 is used as an interface for connecting to a network. The display apparatus 156 displays a GUI (Graphical User Interface) and the like in accordance with the program. The input apparatus 157 is constituted by a keyboard and a mouse, buttons, a touch panel, or the like and is used to enable various operation instructions to be input.

### Details of Processing by Summary Sentence Calculating Unit 130

Hereinafter, contents of processing by the summary sentence calculating unit 130 according to the present embodiment will be described in further detail.

While adhering to the method of Lin et. al. (NPL 2 and NPL 3), the summary sentence calculating unit 130 is configured to also use an amount of increase of information (specifically, coverage) due to a newly-added sentence as a determination condition. Specifically, this may be described as follows.

Let S denote a set of sentences to be input to the summary sentence calculating unit 130 and V⊆S denote a subset created by selecting any of the sentences in S. Since V represents a set of sentences (including cases where the number of sentences is one) to be summarized, V may be referred to as a summary sentence set. Furthermore, let fₛ(V) represent a ratio of words included in any of the sentences in V among all words included in S. As already described, since fₛ(V) represents how many of the words in S are covered by the words in V, fₛ(V) is referred to as coverage.

Basically, the summary sentence calculating unit 130 selects sentences s* that most increase fₛ(V) among S one at a time and adds to V until fₛ(V)≥r. However, the summary sentence calculating unit 130 calculates fₛ(V∪{s*})−fₛ(V) when newly selecting a sentence s* with respect to V, and when fₛ(V∪{s*})−fₛ(V)<θ, the summary sentence calculating unit 130 outputs V at that time point without adding the sentence s* to V and ends processing. θ is a threshold given in advance. In other words, when an amount of increase of coverage is smaller than a given threshold, the summary sentence calculating unit 130 outputs V at that time point and ends processing.

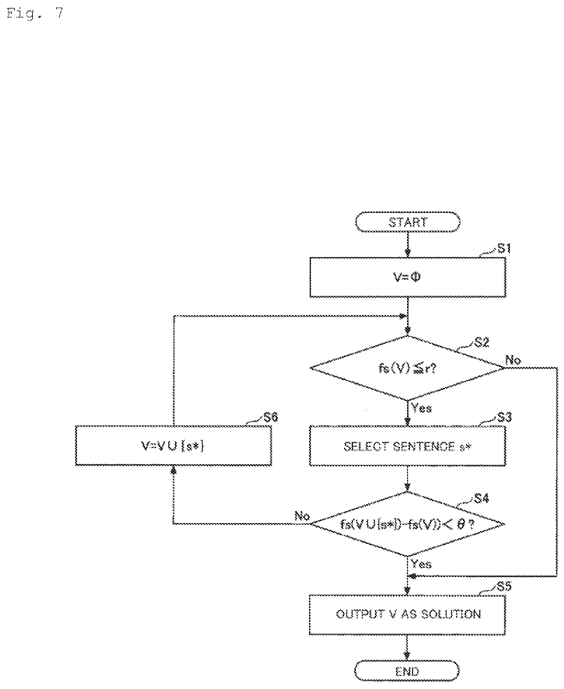

A pseudo-code indicating processing procedures of the summary sentence calculating unit 130 is as shown below. As already described, |s| represents the number of words included in a sentence s. It should be noted that, processing contents represented by the code described below (and processing procedures to be described later with reference to FIG. 7) are merely examples. As long as a method uses how much an amount of information increases due to a newly-added sentence as a determination condition, the method is not limited to the processing contents represented by the code described below (and processing procedures to be described later with reference to FIG. 7).

### Let V=Φ.

While fₛ(V)≥r:

s*=argmax_{s∈s}(fₛ(V∪{s})=fₛ(V))/|s|

if fs(V∪{s*})−fs(V)<θ:
Return V as solution.

V=V∪{s*}

Return V as solution.

In contrast to the end determination with the threshold r using a total amount of coverage, a condition of “if” described above indicates that the amount of increase of coverage when newly adding s* is smaller than the threshold. In other words, when a newly added sentence does not cause coverage to increase by a certain amount or more, it is considered that overlap of information with a sentence added to V before s is large and addition is not performed.

It should be noted that, since many conventional document summarization methods involve summarizing a document so as to satisfy a set condition such as the number of characters, there is no prior art similar to processing that uses an end condition such as that described above in the present embodiment which focuses on an amount of information satisfying predetermined conditions.

Processing procedures to be executed by the summary sentence calculating unit 130 based on the pseudo-code described above will now be explained with reference to the flow chart shown in FIG. 7, As a prerequisite for the flow chart shown in FIG. 7, it is assumed that S has already been input to the summary sentence calculating unit 130.

In S1 (Step 1), the summary sentence calculating unit 130 initializes V to an empty set.

In S2, the summary sentence calculating unit 130 determines whether or not coverage is equal to or smaller than r, and when a determination result is No, the summary sentence calculating unit 130 advances to S5 to output V as a solution. When the determination result is Yes, the summary sentence calculating unit 130 advances to S3.

In S3, the summary sentence calculating unit 130 selects, from S, a sentence s* which is a sentence that maximizes “(fₛ(V∪{s})−fₛ(V))/|s|”.

In S4, the summary sentence calculating unit 130 determines whether or not an amount of increase of the coverage when the sentence s* is added is smaller than a threshold θ. When a determination result is Yes, the summary sentence calculating unit 130 advances to S5 to output V as a solution. When the determination result is No, the summary sentence calculating unit 130 advances to S6.

In S6, the summary sentence calculating unit 130 adopts V to which the sentence s* has been added as new V. After S6, processing is once again executed from S2.

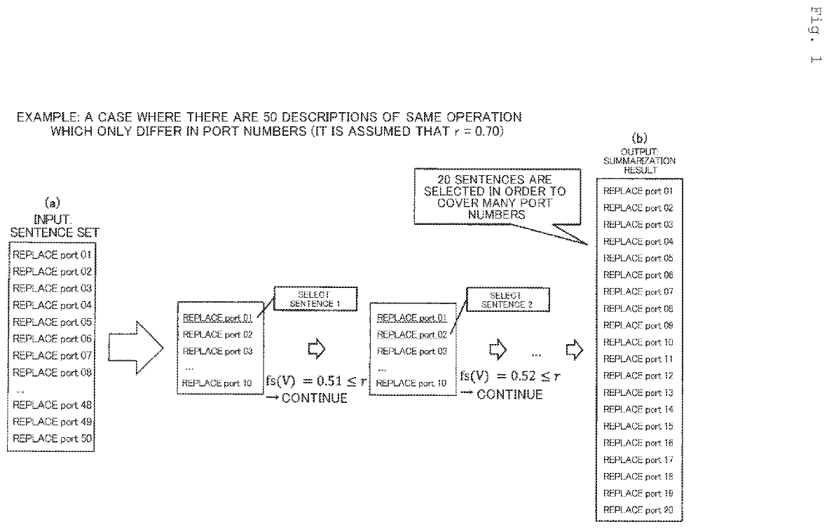

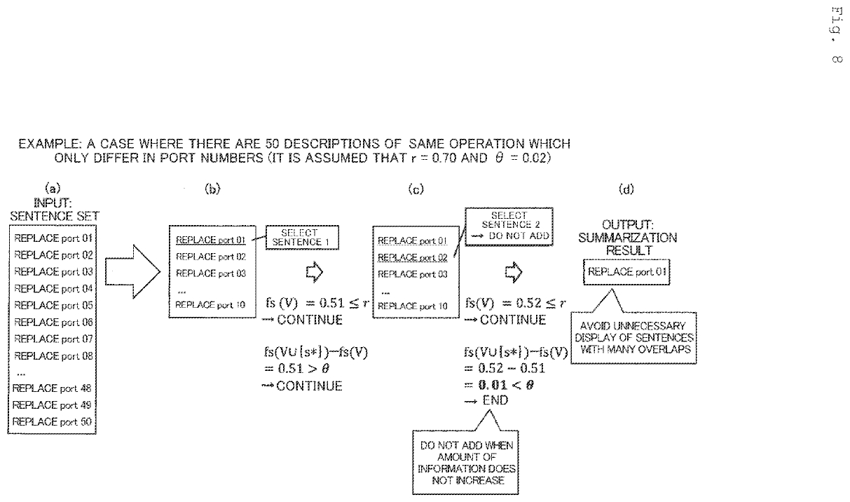

A specific example of the processing by the summary sentence calculating unit 130 described above will be explained with reference to FIG. 3. As shown in (a) in FIG. 8, as is the case in FIG. 1, let us consider a set that is a collection of 50 sentences which read “Replace port 1”, “Replace port 2”, . . . and which only differ in port numbers. In addition, a lower limit r of coverage is assumed to be 0.7 and θ is assumed to be 0.02.

As shown in (b), first, the summary sentence calculating unit 130 selects sentence 1 (Replace port 01) as the sentence s*. At this point, fs(V∪{s})−fs(V) is 0.51 and a condition expressed as “fs(V∪{s})−fs(V)<θ” is not satisfied, but fs(V∪{s})=0.51, which satisfies “fₛ(V)≤r”.

Therefore, the summary sentence calculating unit 130 advances to (c) and selects sentence 2 (Replace port 02) as the sentence s*. At this point, fs(V∪{s})−fs(V) is 0.52−0.51=0.01 and the condition expressed as “fs(V∪{s})−fs(V)<θ” is satisfied. Therefore, even when “fₛ(V)≤r” is satisfied, V (=Replace port 01) is output and processing is ended as shown in (d).

In this manner, unnecessary display with many overlaps can be avoided according to the processing by the summary sentence calculating unit 130.

### Effects of Embodiment

According to the present embodiment, a workflow that presents an operation indicated by each action in a simpler manner as compared to workflows according to prior art can be created. Therefore, in system operations which require quick failure response, operations that need to be promptly performed can be identified and quick countermeasures can be taken.

### Summary of Embodiment

As described above, the present embodiment provides a summary sentence calculation apparatus, including: input means which inputs a set of sentences; and summary sentence calculating means which calculates a summary sentence set from the set of sentences, wherein the summary sentence calculating means repetitively executes processing, until the processing ends, of selecting a predetermined sentence from the set of sentences, calculating, when the predetermined sentence is added to a new summary sentence set, an amount of increase of coverage by the summary sentence set after the addition relative to coverage by the summary sentence set prior to the addition, outputting the summary sentence set prior to the addition and ending the processing when the amount of increase is smaller than a first threshold, and adopting the summary sentence set after the addition as a new summary sentence set when the amount of increase is equal to or larger than the first threshold.

The summary sentence calculating unit 130 is an example of the input means and the summary sentence calculating means, and the summary sentence display apparatus 100 is an example of the summary sentence calculation apparatus.

For example, when coverage of the summary sentence set after the addition is larger than a second threshold, the summary sentence calculating means outputs the summary sentence set after the addition and ends the processing. In addition, the predetermined sentence is, for example, a sentence that most increases the coverage of the summary sentence set after the addition relative to the coverage of the summary sentence set prior to the addition.

While the present embodiment has been described above, it is to be understood that the present invention is not limited to the specific embodiment and that various modifications and changes can be made within the scope of the gist of the present invention as set out in the accompanying claims.

### REFERENCE SIGNS LIST

100 Summary sentence display apparatus
110 Operation record DB
120 Workflow generating unit
130 Summary sentence calculating unit
140 Input/output interface
150 Drive apparatus
151 Recording medium
152 Auxiliary storage apparatus
153 Memory apparatus
154 CPU
155 Interface apparatus
156 Display apparatus
157 Input apparatus

1. A summary sentence calculation apparatus, comprising an input unit, including one or more processors, configured to input a set of sentences: and
a summary sentence calculating unit, including one or more processors, configured to calculate a summary sentence set from the set of sentences, wherein the summary sentence calculating unit is configured to repetitively execute processing, until the processing ends, of selecting a predetermined sentence from the set of sentences, calculating, when the predetermined sentence is added to a new summary sentence set, an amount of increase of coverage by the summary sentence set after the addition relative to coverage by the summary sentence set prior to the addition, outputting the summary sentence set prior to the addition and ending the processing when the amount of increase is smaller than a first threshold, and adopting the summary sentence set after the addition as a new summary sentence set when the amount of increase is equal to or larger than the first threshold

2. The summary sentence calculation apparatus according to claim 1, wherein when coverage of the summary sentence set after the addition is larger than a second threshold, the summary sentence calculating means outputs unit is configured to output the summary sentence set after the addition and ends the processing.

3. The summary sentence calculation apparatus according to claim 1, wherein the predetermined sentence is a sentence that most increases the coverage of the summary sentence set after the addition relative to the coverage of the summary sentence set prior to the addition.

4. A summary sentence calculation method to be executed by a summary sentence calculation apparatus including one or more processors, comprising: an input step of inputting a set of sentences; and a summary sentence calculating step of calculating a summary sentence set from the set of sentences, wherein in the summary sentence calculating step, the summary sentence calculation apparatus
repetitively executes processing, until the processing ends, of selecting a predetermined sentence from the set of sentences, calculating, when the predetermined sentence is added to a new summary sentence set, an amount of increase of coverage by the summary sentence set after the addition relative to coverage by the summary sentence set prior to the addition, outputting the summary sentence set prior to the addition and ending the processing when the amount of increase is smaller than a first threshold, and adopting the summary sentence set after the addition as a new summary sentence set when the amount of increase is equal to or larger than the first threshold.

5. The summary sentence calculation method according to claim 4, wherein in the summary sentence calculating step, when coverage of the summary sentence set after the addition is larger than a second threshold, the summary sentence calculation apparatus outputs the summary sentence set after the addition and ends the processing

6. The summary sentence calculation method according to claim 4, wherein the predetermined sentence is a sentence that most increases the coverage of the summary sentence set after the addition relative to the coverage of the summary sentence set prior to the addition.

7. A non-transitory computer-readable medium storing a program for causing a computer to perform:
inputting a set of sentences; and
calculating a summary sentence set from the set of sentences, including: repetitively executing processing, until the processing ends, of selecting a predetermined sentence from the set of sentences, calculating, when the predetermined sentence is added to a new summary sentence set, an amount of increase of coverage by the summary sentence set after the addition relative to coverage by the summary sentence set prior to the addition, outputting the summary sentence set prior to the addition and ending the processing when the amount of increase is smaller than a first threshold, and adopting the summary sentence set after the addition as a new summary sentence set when the amount of increase is equal to or larger than the first threshold.

8. The non-transitory computer-readable medium according to claim 7, wherein calculating the summary sentence further includes: when coverage of the summary sentence set after the addition is larger than a second threshold, outputting the summary sentence set after the addition and ends the processing.

9. The non-transitory computer-readable medium according to claim 7, wherein the predetermined sentence is a sentence that most increases the coverage of the summary sentence set after the addition relative to the coverage of the summary sentence set prior to the addition.
